(19) United States
(12) Patent Application Publication
(10) Pub. No.: US 2005/0013557 A1
(43) Pub. Date: Jan. 20, 2005

(54) Optical packages and methods for controlling a standoff height in optical packages

(76) Inventor: Daoqiang Lu, Chandler, AZ (US)

Correspondence Address: GROSSMAN & FLIGHT, LLC, 20 N. WACKER DRIVE, SUITE 4220, CHICAGO, IL, 60606, US

(21) Appl. No.: 10/619,348

(22) Filed: Jul. 14, 2003

(51) Int. Cl. G02B 6/42

(52) U.S. Cl. 385/90; 385/91

(57) ABSTRACT

Optical packages and methods for controlling a standoff height in optical packages are disclosed. A disclosed package includes a chip die, a substrate, and a spacer to separate the die and the substrate at a predetermined standoff height. The size of the spacer may be chosen to maximize an optical coupling between the chip and an optical waveguide mounted to the substrate. The spacer is bonded to a conductive pad on the substrate and a conductive pad on the die to create an electrical connection between the substrate and the optical flip chip die.

### TECHNICAL FIELD

The present disclosure pertains to optical packages, and, more particularly, to optical packages and methods for controlling a standoff height in optical packages.

### BACKGROUND

Optical flip chip packages often include a substrate, a waveguide mounted on the substrate, and a flip chip optically coupled to the waveguide. To achieve acceptable optical coupling between the optical flip chip die and the optical waveguide, it is important to control the distance between the flip chip die and the substrate. If the distance between the flip chip die and the substrate is too large, the optical coupling between the optical waveguide and the optical flip chip die may be poor, due to optical signal divergence. If the distance between the flip chip die and the substrate is too small, the optical waveguide and/or the optical flip chip die may be damaged during bonding of the chip to the substrate.

Known methods of maintaining separation distance between the optical flip chip die and the substrate include using large solder balls on the optical flip chip die. As optical flip chip packages exhibit increasingly finer pitch and higher optical I/O (input/output) density, solder bridging (e.g., electrical shorts created in the soldering process when the solder melts and inadvertently connects adjacent electrical contacts) has become a serious problem. Increasing the amount of solder between the flip chip and the substrate increases the likelihood of solder bridging. Therefore, using large solder balls to achieve a desired separation between the optical flip chip die and the substrate during the bonding process, increases the likelihood of solder bridging.

### BRIEF DESCRIPTION OF THE DRAWINGS

FIG. 1 is a cross-sectional illustration of an example optical package.

FIG. 2 is an illustration of the example optical package of FIG. 1 after bonding has occurred.

FIG. 3 is a cross-sectional illustration of a second example optical package.

FIG. 4 is an illustration of the second example optical package of FIG. 3 after bonding has occurred.

### DETAILED DESCRIPTION

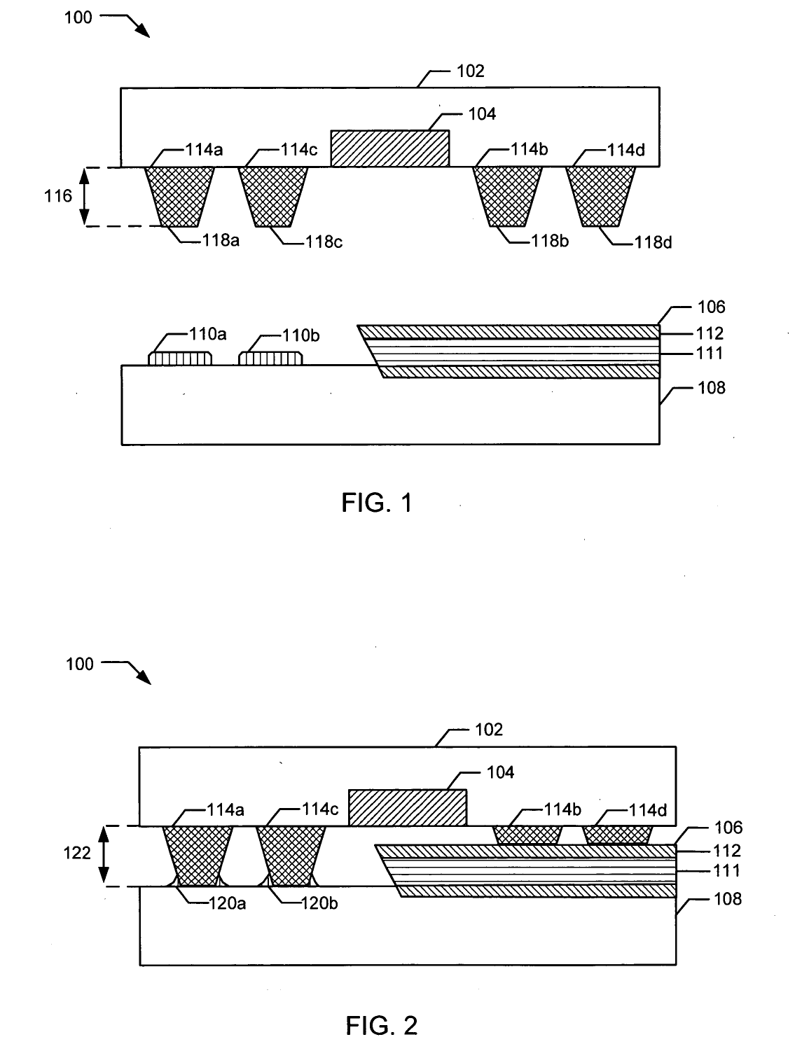

FIG. 1 is an illustration of an example optical chip package 100. Although the example optical package 100 of FIG. 1 employs an optical flip chip 102, the disclosed methods for controlling a distance between a chip die and a substrate, are not limited to flip chips. Instead the disclosed optical package may include, and the disclosed methods may be applied to, other types of chips including conventional mount chips. Also, the flip chip 102 or the chip may be any type of integrated circuit with any type of functionality (e.g., an EEPROM die/substrate, a processor, an ASIC, etc.).

In the illustrated example, the optical package 100 includes an optical flip chip die 102 with an optical element 104 optically coupled to an optical waveguide 106 mounted on a substrate 108. In addition to the optical waveguide 106, conductive pads are coupled to the substrate 108 to provide electrical contact points. For example, in FIG. 1 the conductive pads are solder pads 110 electrically coupled to a circuit carried by the substrate 108. The optical waveguide 106 may be implemented by any type of channel or conduit that provides a means to propagate light to and/or from the optical element 104. For example, the waveguide 106 may include a core 111 having a first index of refraction and cladding layers 112 having a second index of refraction. The waveguide 106 may be, for example, a planar waveguide or an optical fiber. The optical element 104 may be implemented by an optical emitter such as a VCSEL, an optical receiver such as a photodiode, and/or by an optical transceiver. Also, the substrate 108 may be implemented by any type of substrate such as a printed circuit board, an integrated circuit package, etc.

In the example optical package 100 illustrated in FIG. 1, the optical flip chip die 102 has been provided with spacers 114a-114d. As used in this patent, the term “spacer” refers to any structure that is used to create and/or maintain a degree of separation between any two structures. By way of example, not limitation, a spacer may be a leg, a post, a stud, a ball, a blob, a wedge, a brace, etc.

The spacers 114a-114d of the illustrated example provide spacing between the optical flip chip die 102 and the substrate 108 when the package 100 is assembled. To this end, the spacers 114a-114d of FIG. 1 have a length 116 that is selected to separate the chip die 102 from the substrate 108 and/or the waveguide 106 a distance which substantially maximizes the optical coupling between the optical waveguide 106 and the optical element 104. The spacers 114a-114d may be constructed of any material, provided the material satisfies any mechanical or electrical requirements that may be imposed on it by the manufacturing process, the chip die 102, the substrate 108, or any other part of the optical package 100. For instance, the material should be selected to have a melting point above the melting point of the solder used in the package 100 to ensure the lengths 116 of the spacers 114a-114d are not modified as a result of the soldering process. In the illustrated example, the spacers 114a-114d are made of a conductive material such as gold. However, persons of ordinary skill in the art will appreciate that other materials may likewise be appropriate.

The spacers 114a-114d may be mounted to the chip 102 or the substrate 108 using any desired technique. For example, the spacers 114a-114d may be mounted by a wirebonder. After the spacers 114a-114d are mounted to the optical flip chip die 102 or the substrate 108, the free ends 118a-118d of the illustrated spacers 114a-114d are coined or otherwise flattened. The free ends 118a-118d may be flattened to enhance the uniformity of the spacing between the chip die 102 and the substrate 108 and/or to provide a better electrical contact with the substrate 108 and/or the solder pads 110. In the illustrated example, the package 100 includes four spacers 114a, 114b, 114c, and 114d. Persons of ordinary skill in the art will readily appreciate, however, that any desired number of spacers (e.g. 1, 2, 3, 4, or more than 4 spacers) maybe alternatively employed.

FIG. 2 illustrates the example optical package 100 of FIG. 1 after the optical flip chip die 102 and the substrate 108 have been bonded together such that an electrical connection has been established between the optical flip chip die 102 and the substrate 108. In the example package of FIG. 2, the optical flip chip die 102 and the substrate 108 are bonded through thermocompression bonding. During thermocompression bonding, the solder pads 110a and 110b of FIG. 1 are melted to form solder joints 120a and 120b with the spacers 114a and 114c. Although the example package 100 is bonded through thermocompression bonding, other forms of bonding may be employed such as a conductive epoxy or a mechanical bond.

In the example of FIG. 2, the spacers 114b and 114d form electrical connections with solder pads which are obstructed from view by the optical waveguide 106. In other words, the spacers 114b and 114d form electrical connections with solder pads which are behind the optical waveguide 106 in FIG. 2. Thus, the spacers 114b and 114d are partially occluded by the waveguide 106 in the view of FIG. 2.

After the die has been bonded to the substrate 108, a “standoff height” 122 (e.g., a distance between the chip die 102 and the substrate 108) is established. The standoff height 122 is controlled by the lengths 116 of the spacers 114a-114d. For example, if the desired standoff height is 2 mm, the length of the spacers 114a-114d are selected to be approximately 2 mm, taking into consideration any effect the solder pads 110a and 110b may have on the standoff height 122. By controlling the length 116 of the spacers 114a-114d, the standoff height 122 is set and, therefore, the distance between the optical element 104 and the optical waveguide 106 is established.

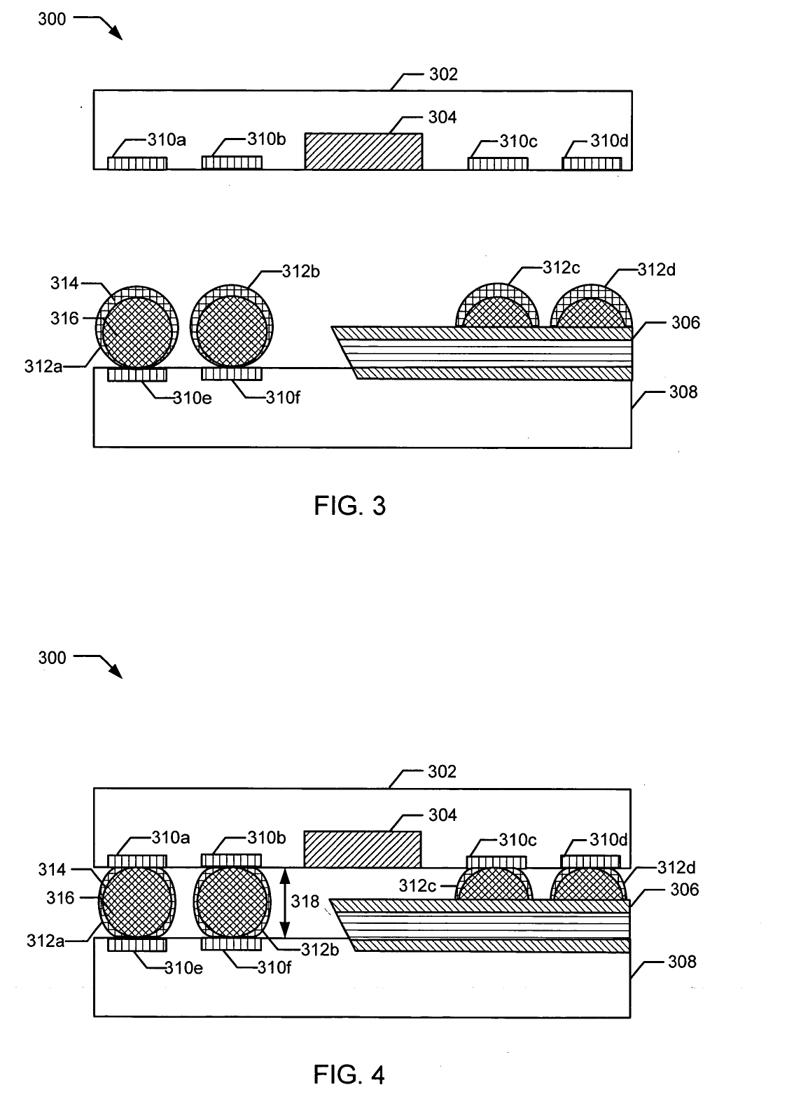

FIG. 1 and FIG. 2 illustrate an example optical package 100 where the standoff height 122 is established by spacers 114a-114d coupled to the optical flip chip die 102. A second example optical package 300 is shown in FIG. 3 and FIG. 4. In the example of FIG. 3, the optical flip chip die 302 includes an optical element 304 which is optically coupled to an optical waveguide 306 mounted to a substrate 308. Conductive pads 310a-310f are coupled to the substrate 308 and the optical flip chip die 302.

Instead of using gold spacers 114a-114d to establish the standoff height 122 as in the example of FIG. 1, the example package 300 of FIGS. 3-4 uses coated spacers 312a-312d. The coated spacers 312a-312d of FIGS. 3-4 comprise an outer coating 314 of a material capable of creating electrical connections (e.g., solder) and having a first melting point and an inner core 316 of a material that has a second melting point higher than the melting point of the outer coating 314. The inner core 316 of the coated spacers is constructed so as not to melt or otherwise deform during the bonding process. The inner core 316 may be implemented by, for example, a copper or glass ball. The outer coating 314 of the coated spacers 312a-312d is intended to melt to form a bond. The coated spacers 312a-312d may be mounted to the die or the substrate prior to the assembly of the package 300. In the illustrated example, the coated spacers 312a-312d are soldered to the solder pads (e.g., 310e and 310f) of the substrate 308 before the chip is soldered to the coated spacers 312a-312d.

Although in the illustrated example, the coated spacers 312a-312d are balls, persons of ordinary skill in the art will appreciate that the coated spacers 312a-312d can have any desired shape. For example, the coated spacers 312a-312d could be shaped to resemble a trapezoid, a leg, a stud, a ball, a blob, a wedge, a brace, etc.

FIG. 4 illustrates the second example optical package 300 after the optical flip chip die 302 and the substrate 308 have been bonded together, through a process such as thermocompression bonding, such that electrical connections between the optical flip chip die 302 and the substrate 308 have been established. Thermocompression bonding melts the outer coating 314 of the coated spacers 312a-312d and forms electrical connections between the conductive pads 310a-310f on the substrate 308 and the optical flip chip die 302. The diameter of the inner core 316 of the coated spacers 312a-312d is chosen to create a desired standoff height 318.

From the foregoing, persons of ordinary skill in the art will appreciate that the disclosed optical packages and methods use one or more spacers to maintain a desired distance between a chip die and a substrate during an assembly process. Depending on the optical package, different size and/or different shaped spacers may be appropriate. The size of the spacers may be chosen to, for example, substantially maximize an optical coupling, decrease the amount of electrical loss, and/or substantially maximize heat transfer. The spacers may be coupled to the chip die, to the substrate, or to both the chip and the substrate. The spacers may be conductive and/or coated with conductive material.

Although certain example methods, apparatus and articles of manufacture have been described herein, the scope of coverage of this patent is not limited thereto. On the contrary, this patent covers all apparatus, methods and articles of manufacture fairly falling within the scope of the appended claims either literally or under the doctrine of equivalents.

1. A method to control a distance between a chip die and a substrate, the method comprising:
coupling at least one spacer to the chip die or the substrate; and
bonding the chip die to the substrate, such that the spacer substantially defines the distance between the chip die and the substrate.

2. A method as defined in claim 1, wherein the at least one spacer comprises at least one of a stud, a ball, a gold stud, a trapezoid, a leg, a post, a blob, a wedge, or a brace.

3. A method as defined in claim 1, wherein an end of the at least one spacer is flattened.

4. A method as defined in claim 1, wherein the at least one spacer has a core and a solder covering.

5. A method as defined in claim 1, wherein the chip die comprises a flip chip die.

6. A method as defined in claim 5, wherein bonding the flip chip die to the substrate optically couples an optical element of the flip chip to a waveguide mounted on the substrate

7. A method as defined in claim 1, wherein the substrate comprises at least one conductive pad coupled to its surface.

8. A method as defined in claim 7, wherein the at least one conductive pad is a solder pad.

9. A method as defined in claim 1, wherein bonding the die to the substrate comprises creating a solder joint between the at least one spacer and the substrate.

10. A method as defined in claim 9, wherein the solder joint between the spacer and the substrate creates an electrical connection between the chip die and the substrate.

11. A method as defined in claim 1, wherein bonding the chip to the substrate comprises thermocompression bonding the chip to the substrate.

12. A method to mount an optical flip chip die comprising:
establishing a distance between the optical flip chip and an optical waveguide;
coupling at least one spacer to the substrate or the flip chip die; and
thermocompression bonding the at least one spacer to at least one conductive pad on the optical flip chip die or the substrate.

13. A method as defined in claim 12, wherein the at least one spacer comprises at least one of a stud, a ball, a gold stud, a trapezoid, a leg, a post, a blob, a wedge, or a brace.

14. A method as defined in claim 12, wherein the distance between the optical flip chip and the optical waveguide comprises a distance that substantially maximizes an optical coupling between the optical flip chip and the optical waveguide.

15. A method as defined in claim 12, wherein the at least one spacer has a core and a solder covering.

16. A method as defined in claim 12, wherein the core has a first melting point, the solder covering has a second melting point, and the first melting point is greater than the second melting point.

17. A method as defined in claim 12, wherein the thermocompression bonding creates an electrical connection between the optical flip chip and the substrate.

18. An optical package comprising:
a die;
a substrate; and
a spacer structured to separate the die and the substrate at a predetermined standoff height.

19. An optical package as defined in claim 18, further comprising:
a conductive pad operatively coupled to one of the substrate and die; and
a bond to couple the spacer to the conductive pad to create an electrical connection between the substrate and the die.

20. An optical package as defined in claim 19, wherein the bond is a thermocompression bond.

21. An optical package as defined in claim 19, wherein the conductive pad is a solder pad.

22. An optical package as defined in claim 19, wherein the spacer comprises at least one of a stud, a ball, a gold stud, a trapezoid, a leg, a post, a blob, a wedge, or a brace.

23. An optical package as defined in claim 18, further comprising a waveguide mounted on the substrate, the predetermined standoff height being selected to promote optical coupling between the die and the waveguide.

24. An optical package as defined in claim 18, wherein the die comprises an optical flip chip die.
